(19) United States
(12) Patent Application Publication
(10) Pub. No.: US 2014/0295560 A1
(43) Pub. Date: Oct. 2, 2014

(54) Device and Method For Predicting Corrosion

(71) Applicant: Rotimi A. Ojifinni, Richmond, TX (US)

(72) Inventor: Rotimi A. Ojifinni, Richmond, TX (US)

(21) Appl. No.: 14/170,337

(22) Filed: Jan. 31, 2014

Related U.S. Application Data
(60) Provisional application No. 61/806,214, filed on Mar. 28, 2013.

(51) Int. Cl. G01N 17/00

(52) U.S. Cl. CPC G01N 17/00
USPC 436/6; 422/53

(57) ABSTRACT

The present disclosure provides a device for predicting corrosion in a tubular element that receives hydrocarbons. The device includes a housing, a first sensor, and a location tracking device. The first sensor is partially within the housing and detects one of first physical, chemical and electrical signals of a fluid within the tubular element at a plurality of locations within the tubular element. The location tracking device is within the housing and operatively connected to the first sensor. The location tracing device determines an axial and circumferential position of the first sensor at each of the plurality of locations.

### CROSS REFERENCE TO RELATED APPLICATIONS

This application claims the priority benefit of U.S. Patent Application 61/806,214 filed Mar. 28, 2013 entitled DEVICE AND METHOD FOR PREDICTING CORROSION, the entirety of which is incorporated by reference herein.

### FIELD OF THE INVENTION

The disclosure relates generally to the field of corrosion monitoring and, more particularly, to a device and method for predicting corrosion in a tubular element that receives hydrocarbons.

### BACKGROUND

This section is intended to introduce various aspects of the art, which may be associated with embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Some conventional devices and methods detect the presence of corrosion within a tubular element that receives hydrocarbons by attaching a fixed sensor to the wall of the tubular element. The sensor measures the amount of wall loss at the location of the sensor. Often the sensor is located at the inlet or outlet of the tubular element. Other conventional devices and methods detect the presence of corrosion within a tubular element that receives hydrocarbons by moving a sensor along a wall of a tubular element. The sensor is positioned such that it makes intimate contact with the internal diameter (ID) of the tubular element before any portion of the tubular element corrodes so that the sensor can detect wall loss and, therefore, corrosion in the tubular element.

Disadvantages with conventional devices and methods result because the presence of corrosion is only determined at the location of the sensor as opposed to along the entire tubular element. Moreover, disadvantages result because the place where corrosion is detected is often not representative of the entire tubular element. Yet additional disadvantages result because the corrosion is detected after the tubular element corrodes and is not predicted before it occurs. Additional disadvantages with sensors that can be moved along the wall of the tubular element include the large size of each sensor and the requirement to install additional equipment to launch and retrieve a sensor package that holds the sensor. For some offshore locations, there is no space to install the launching and retrieval equipment.

A need exists for improved technology, including technology that may address one or more of the above described disadvantages of conventional devices and methods. For example, a need exists for a device and method that predicts corrosion in a tubular element that receives hydrocarbons based on information about leading indicators of corrosion.

### SUMMARY

The present disclosure provides a device and method for predicting corrosion, among other things.

The present disclosure includes a device for predicting corrosion in a tubular element that receives hydrocarbons. The device comprises a housing; a first sensor partially within the housing and that detects one of first physical, chemical and electrical signals of a fluid within the tubular element at a plurality of locations within the tubular element; and a location tracking device within the housing and operatively connected to the first sensor, wherein the location tracing device determines an axial and circumferential position of the first sensor at each of the plurality of locations.

The present disclosure includes a system for predicting corrosion in a tubular element that receives hydrocarbons. The system comprises a device constructed and arranged to predict corrosion in the tubular element. The device includes a first housing; a first sensor partially within the first housing and that detects one of first physical, chemical and electrical signals of a fluid within the tubular element at a plurality of locations within the tubular element; and a location tracking device within the first housing and operatively connected to the first sensor, wherein the location tracking device determines an axial and circumferential position of the first sensor at each of the plurality of locations.

The present disclosure includes a method of predicting corrosion in a tubular element that receives hydrocarbons. The method comprises measuring at least one of a first physical, chemical and electrical signal of a fluid within the tubular element at a first location within the tubular element using a sensor; determining a first axial and circumferential position of the sensor at the first location; moving the sensor to a second location within the tubular element that is different from the first location; and measuring at least one of a second physical, chemical and electrical signal of the sensor at the second location.

The present disclosure also includes a method of producing a hydrocarbon. The method comprises acquiring a hydrocarbon within a tubular element; and predicting corrosion in the tubular element. The predicting includes: measuring at least one of a first physical, chemical and electrical signal of a sensor measuring at least one of a first physical, chemical and electrical signal of a fluid within the tubular element at a first location within the tubular element using a sensor; determining a first axial and circumferential position of the sensor at the first location; moving the sensor to a second location within the tubular element that is different from the first location; and measuring at least one of a second physical, chemical and electrical signal of the sensor at the second location.

The foregoing has broadly outlined some features of the present disclosure in order that the detailed description that follows may be better understood. Additional features will also be described herein.

### BRIEF DESCRIPTION OF THE DRAWINGS

These and other features, aspects and advantages of the disclosed embodiments will become apparent from the following description, appending claims and the accompanying embodiments shown in the drawings, which are briefly described below.

FIG. 1 is a schematic illustration of a tubular element and a device for predicting corrosion in the tubular element.

FIG. 2a is a schematic illustration of a device and a moving mechanism.

FIG. 2b is a schematic illustration of a device and a moving mechanism.

FIG. 2c is a schematic illustration of a device and a moving mechanism.

FIG. 3 is a diagram of sensor output data.

FIG. 4 is a flowchart of methods within the scope of the present disclosure.

It should be noted that the figures are merely examples of the present disclosure and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to what is illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates. Many features of the disclosure are shown in the figures; although it will be apparent to those skilled in the relevant art that some features that are not relevant to the present disclosure may not be shown in the figures for the sake of clarity.

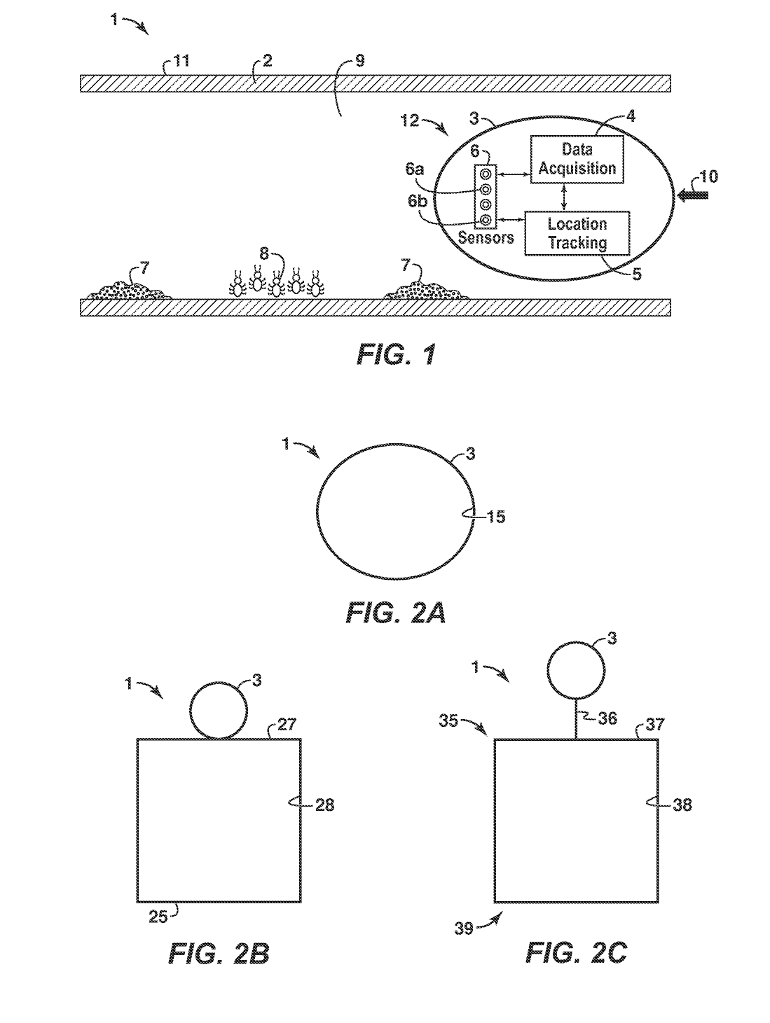

FIG. 1 shows a system 1 for predicting corrosion in a tubular element 11 that includes a device 12 constructed and arranged to predict corrosion in the tubular element 11. The term predicting includes foreshadowing the presence of corrosion in the tubular element 11 or detecting actual corrosion in the tubular element 11 so that the possibility and/or actual presence of corrosion may be detected within the tubular element 11 by the device 12. The device 12 includes a housing 3, a sensor 6 and a location tracking device 5.

The housing 3 may be any suitable shape and size that is constructed and arranged to fit within the tubular element 11, house electronics such as the sensor 6 and location tracking device 5, and accommodate travel through a fluid 9, such as a hydrocarbon. For example, the housing 3 may include one of a spherical (FIG. 1), cylindrical and rectangular shape. Alternatively, the housing 3 may be any other suitable shape. For example, the housing 3 may be a hot-dog shape. The housing 3 may have an outer diameter equal to or substantially equal to a smallest inner diameter of the tubular element 11. Alternatively, the housing 3 may have an outer diameter that is smaller than a smallest inner diameter of the tubular element 11 so that it is easier for the device 12 to move within the tubular element 11 to predict corrosion. When the housing 3 has a smaller diameter, the requirement for space for equipment to launch and retrieve the sensor may be eliminated. Moreover, the smaller diameter may allow multiple sensors with different capabilities to be launched at the same time or within a relatively short period of time.

The housing 3 may be any suitable material that can house electronics without the electronics being destroyed by fluid 9 and/or may be a material having a density one of equal to and substantially equal to a density of the fluid 9 within the tubular element 11. For example, the housing 3 may comprise a robust material, such as polyurethane. When the housing 3 comprises a material having a density equal to the density of the fluid 9, the housing 3 may naturally be propelled through the fluid in the motion of direction 10 (FIG. 1) of the fluid such that corrosion can be predicted at multiple locations in the tubular element 11 with the device 12.

The sensor 6 is only partially within the housing 3 so that the sensor 6 may detect one of first physical, chemical and electrical signals of the fluid 9 within the tubular element 11 at a plurality of locations within the tubular element 11. Any portion of the sensor 6 may be outside of the housing 3 as long as that portion of the sensor 6 may detect one of first physical, chemical and electrical signals of the fluid 9. The portion of the housing 3 that is open to the fluid so that the sensor 6 may be partially within and outside of the housing 3 has a seal that prevents the fluid 9 from entering the housing 3 and destroying any electronics housed within the housing 3.

The one of first physical, chemical and electrical signals may comprise any suitable signal that may be converted into sensor output. For example, the one of the first physical, chemical and electrical signals may comprise one of impedance, color, conductivity, optical absorbance, hydrogen ion concentration, temperature, pressure and velocity.

The sensor 6 may comprise one sensor (i.e., a first sensor) or the sensor 6 may comprise a plurality of sensors 6a (e.g., a first sensor, a second sensor) (FIG. 1). If the sensor 6 comprises one sensor, the sensor may be used to detect a first type of signal and another device 12 having a sensor that detects a second type of signal, which is different from the first type of signal (e.g. the first type of signal may be a physical signal and the second type of signal may be an electrical signal) may be used if it's desired to detect two different types of signals. If the sensor 6 comprises a plurality of sensors 6a, each of the sensors 6a may detect a different type of signal and may be partially within the housing 3. For example, one of the sensors may detect a physical signal and another may detect an electrical signal.

The location tracking device 5 may be within the housing 3 and/or operatively connected to the sensor 6. The location tracking device 5 may be within the housing 3 so that the electronic component(s) of the location tracking device 5 may be protected from the fluid 9. The location tracking device 5 may be operatively connected to the sensor 6 so that the location tracking device 5 can determine an axial and circumferential position of the sensor 6 at each of the plurality of locations within the tubular element 11. The location tracking device 5 may use an accelerometer to determine the axial and circumferential position of the sensor 6.

In addition to using the accelerometer, the location tracking device 5 may also use another tracking element, such as a weld sensor, gyroscope and/or odometer, to account for the drift error in the accelerometer caused by deviations in the performance of the accelerometer that occur after the accelerometer is calibrated. The drift error is more likely to occur when the accelerometer is not at the input (i.e. opening) or output (i.e., closing) of the tubular element because the input and output of the tubular element have known locations. The weld sensor may be any suitable sensor that can detect the presence of welds in the tubular element 11. The location of the welds may be known before the sensor 6 makes detections so that the sensors detection of a weld by contacting the weld can help determine the location of the sensor 6 within the tubular element 11. Alternatively, the location of the welds may be known by if the weld sensor detects a weld due to the geometric difference between a weld and those portions of the tubular element 11 that do not contain a weld.

In addition to including the housing 3, sensor(s) 6, 6a and location tracking device 5, the device 12 may also include a data acquisition unit 4 (FIG. 1). The data acquisition unit 4 may be within the housing 3 so that the electronic components of the data acquisition unit 4 are protected from the fluid 9. The data acquisition unit 4 may also be operatively connected to the sensor 6 so that the data acquisition unit 4 can receive the signal from the sensor 6 and convert one of the physical, chemical and electrical signals into information relevant to the tubular element 11. The information may include at least one of a presence of water, solids 7, bugs 8, and biofilm within the tubular element 11 (FIG. 1). The presence of the water, solids, bugs, and/or biofilm may indicate that corrosion is likely to occur in the tubular element 11 or that corrosion has occurred in the tubular element 11 at the location of the sensor 6. The location tracking device 5 may measure the axial and circumferential position of the sensor 6 while the data acquisition unit 4 converts one of the physical, chemical and electrical signals into information relevant to the tubular element 11.

If it is determined that corrosion is likely to occur or has occurred, preventive steps can be undertaken to decrease the likelihood that corrosion will occur and/or to prevent further corrosion in the tubular element 11. The ability of the device 12 to predict the presence of corrosion within the tubular element 11 can increase the longevity of the tubular element and/or increase operating costs of the tubular element 11. In addition to being operatively connected to the sensor 6, the data acquisition unit 4 may operatively connect to the location tracking device 5.

In addition to including the device 12, the system 1 may also include a moving mechanism (FIGS. 2a-2c) constructed and arranged to move the housing 3 within the tubular element 11. As shown in FIG. 2a, the moving mechanism 15 may comprise the housing 3. When the moving mechanism 15 comprises the housing 3, the moving mechanism 15 may have a density one of equal to and substantially equal to a density of the fluid 9 so that the housing 3 flows in the same direction 10 (FIG. 1) as the fluid 9. Alternatively, as shown in FIGS. 2b-2c, the moving mechanism 25, 35 may comprise a tubular element mechanism 25, 35 that moves within the tubular element 11 and attaches to the housing 3.

The tubular element mechanism 25 may directly attach (FIG. 2b) to the housing 3. When the tubular element mechanism 25 directly attaches to the housing 3 (FIG. 2b), the tubular element mechanism 25 may attach to the housing 3 via any suitable way (e.g. mounted, adhered) and the housing 3 may attach to the back 27 or front 28 of the tubular element mechanism 25. The tubular element mechanism 25 may comprise any suitable tool that moves within a tubular element 11. For example, the tubular element mechanism 25 may comprise a pig or a well logging tool.

Alternatively, the tubular element mechanism 35 may indirectly attach to the housing 3 (FIG. 2c). When the tubular element mechanism 35 indirectly attaches to the housing 3 (FIG. 2c), the tubular element mechanism 35 may also include a tubular element body 39 and a cable or other suitable tethering mechanism 36 that can attach to the body 39 and the housing 3. The tethering mechanism 36 may attach to the body 39 via any suitable way (e.g. mounted, adhered). Moreover, the housing 3 may attach to the tethering mechanism 36 via any suitable mechanism (e.g. mounted, adhered). The tubular element body 39 may comprise any suitable tool that moves within a tubular element 11. For example, the tubular element body 39 may comprise a pig or a well logging tool.

The housing 3 may attach to the back (FIG. 2c) or front of the tubular element mechanism 35. When the housing 3 attaches to the back of the tubular element mechanism 35, the tethering mechanism 36 extends from the back 37 of the body 39 (FIG. 2c). When the housing 3 attaches to the front of the tubular element mechanism 35, the tethering mechanism 36 extends from the front 38 of the body 39.

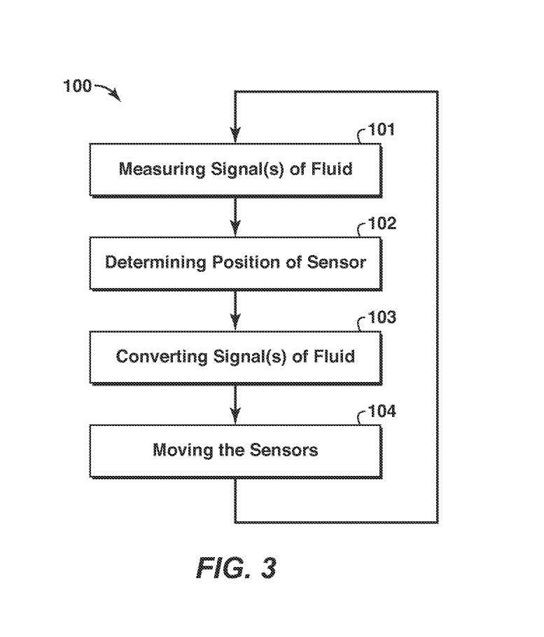

FIG. 3 shows a method 100 of predicting corrosion in a tubular element 11 that receives hydrocarbons. The method 100 may include measuring at least one of a first physical, chemical and electrical signal of the fluid 9 within the tubular element 11 at a first location within the tubular element 101. The sensor 6 may be used to measure at least one of the first physical, chemical and electrical signal of the fluid 9. The method 100 may also include determining a first axial and circumferential position of the sensor 6 at the first location 102. The method 100 may determine the position using the location tracking device 5. Additionally, the method 100 may include converting at least one of the first physical, chemical and electrical signal into information relevant to the tubular segment 11 at the first location 103 and moving the sensor to a second location within the tubular element 11 that is different from the first location 104 so that corrosion can be predicted at different locations in the tubular element 11. Although FIG. 3 shows determining the position of the sensor before converting the signal of the fluid, the method may convert the signal of the fluid before determining the position of the sensor. The signal conversion and position determination can also be performed concurrently. To predict the presence of corrosion at different locations in the tubular element 11 by obtaining different signals (e.g. a first signal, a second signal), the method may include repeating steps 101-104 (FIG. 3).

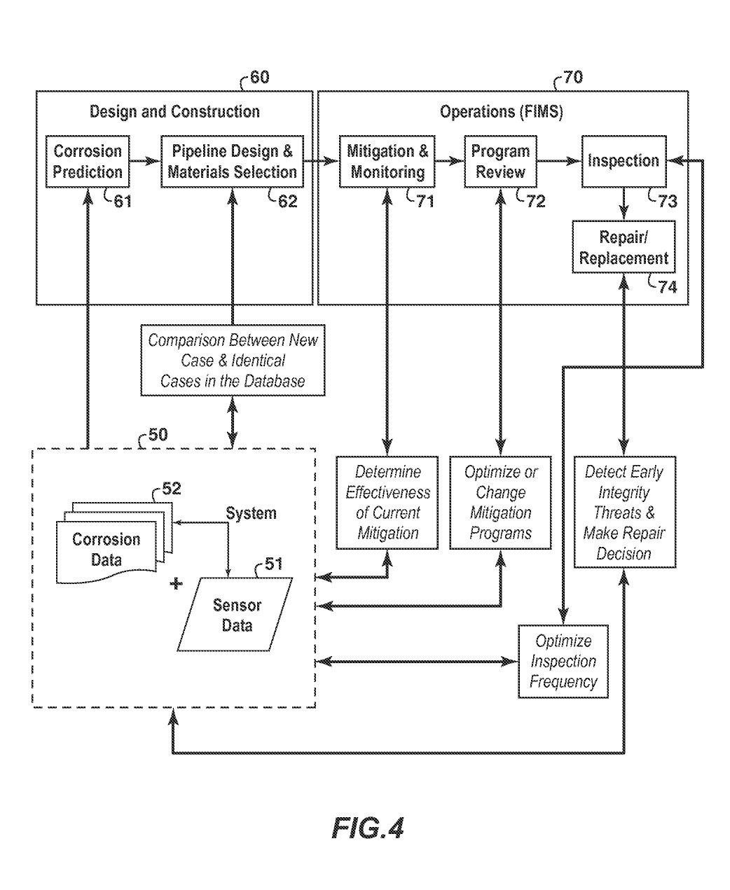

As shown in FIG. 4, the data obtained from the sensor 6 may be used for integrity management of the tubular element 11. For example, the first part of the data obtained may be used in the system 50 (FIG. 4). The system 50 integrates the sensor data 51 and existing corrosion data 52 to influence the design and construction 60 of the tubular element 11. The existing corrosion data 52 may be any suitable existing data. For example, the existing corrosion data 52 may be at least one of historical corrosion monitoring data, inspection data, fluid chemistry analysis data, failure history data, historical trends in sensor data, etc.

Specifically, the integrated data obtained from the sensor 6 and the existing corrosion data may be used to predict corrosion 61 in the tubular element 11. Based on the prediction or corrosion in the tubular element 11, the integrated data may be used to design/modify 62 the tubular element 11 and/or the materials of the tubular element 11. Based on the system 50 and/or design and construction 60, operations 70 may be performed to mitigate and/or remove corrosion. For example, using the information from the system 50 and/or design and construction 60, steps can be implemented to mitigate and/or monitor 71 the presence of corrosion. Mitigating and/or monitoring the presence of corrosion 71 can also include using the system 50 to determine the effectiveness of the current mitigation technique. Using the information from the system 50 and/or design and construction 60, steps may be implemented to review the current mitigation technique 72. Reviewing the current mitigation technique 73 may include optimizing or changing the current mitigation technique to prevent or alleviate corrosion. Using the information from the system 50 and/or design and construction 60, steps can be implemented to inspect 73 the tubular element 11 with something other than the sensor 6 and/or all or a portion of the tubular element 11 can be repaired/replaced 74 if needed to remove corrosion or prevent corrosion from occurring. Inspecting 73 may also occur if an optimized inspection frequency is determined based on information from the system 50 and/or the design and construction 60. Inspecting 73 may help optimize inspection frequency. Repairing/replacing 74 may also occur if early detection of integrity threats are determined based on information from the system 50 and/or the design and construction 60. Repairing/replacing 74 may help detect early integrity threats to make repair decisions.

Based on experience or learning by the operations 70 from the sensor data over a period of time, feedback can be provided to the design and construction 60 to implement improvement in corrosion performance of a tubular element. For example, if a material has been observed to corrode in a given type of environment, the operations 70 can provide feedback to the design and construction 60 on materials selection 62 to improve future performance.

The inspection 73 of the operations 70 may differ from the corrosion prediction 61 of the design and construction 60. For example, since the sensor is not designed to provide direct wall loss information about a tubular element to predict corrosion, periodic inspection may be necessary to determine wall loss; spot inspection may be necessary to obtain wall loss data. Moreover, for example, sensor data from the sensor may guide the operations 70 to determine locations expected to have the worst case corrosion. Sensor data may be very useful in providing guidance about which locations to be inspected. For tubular elements that are piggable, wall loss data is provided as a single number without any information about what factors might have contributed to the wall loss. In some instances, inspection 73 and corrosion prediction 61 may be used together. For example, when the wall loss data, which is obtained from inspecting, is coupled with sensor data, operations 70 may be able to identify the root-cause of wall loss. Specifically, if inspection data shows wall loss at the vicinity of biofilm accumulation based on sensor data, the inspection data and sensor data may be used to determine that corrosion due to bugs is responsible for the wall loss.

Persons skilled in the technical field will readily recognize that in practical applications of the disclosed methodology, it must be performed on a computer, typically a suitably programmed digital computer. Further, some portions of the detailed descriptions are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and/or otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing,” “measuring,” “calculating,” “converting,” “determining,” “displaying,” “copying,” “producing,” “storing,” “accumulating,” “adding,” “applying,” “identifying,” “acquiring, acquiring,” “consolidating,” “waiting,” “including,” “executing,” “maintaining,” “updating,” “creating,” “implementing,” “generating” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is important to note that the steps depicted in FIGS. 3-4 are provided for illustrative purposes only and a particular step may not be required to perform the inventive methodology. The claims, and only the claims, define the inventive system and methodology.

One or more embodiments of the present disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.). The computer-readable medium may be non-transitory.

Furthermore, as will be apparent to one of ordinary skill in the relevant art, the modules, features, attributes, methodologies, and other aspects of the disclosure can be implemented as software, hardware, firmware or any combination of the three. Of course, wherever a component of the present disclosure is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present disclosure is in no way limited to implementation in any specific operating system or environment.

Disclosed aspects may be used in hydrocarbon management activities. As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/ or abandoning hydrocarbon resources, reviewing prior hydrocarbon management decisions, and any other hydrocarbon-related acts or activities. The term “hydrocarbon management” is also used for the injection or storage of hydrocarbons or CO₂, for example the sequestration of CO₂, such as reservoir evaluation, development planning, and reservoir management. In one embodiment, the disclosed methodologies and techniques may be used to extract hydrocarbons from a subsurface region. In such an embodiment, determinations made be made to predict corrosion in the tubular element that acquires the hydrocarbons where the predicting has been improved using the methods and aspects disclosed herein. Based at least in part on the prediction, the presence and/ or location of possible corroded portions of the tubular element are predicted. Hydrocarbon extraction may be conducted, before or after the prediction, to remove hydrocarbons from the subsurface region that the tubular element traverses. Hydrocarbon extraction may be accomplished by drilling a well using oil drilling equipment. The equipment and techniques used to drill a well and/or extract the hydrocarbons are well known by those skilled in the relevant art. Other hydrocarbon extraction activities and, more generally, other hydrocarbon management activities, may be performed according to known principles.

The following lettered paragraphs represent non-exclusive ways of describing the present disclosure.

A. A device for predicting corrosion in a tubular element that receives hydrocarbons may comprise a housing; a first sensor partially within the housing and that detects one of first physical, chemical and electrical signals of a fluid within the tubular element at a plurality of locations within the tubular element; and a location tracking device within the housing and operatively connected to the first sensor, wherein the location tracing device determines an axial and circumferential position of the first sensor at each of the plurality of locations.

A1. A device according to A, wherein the housing comprises a material having a density one of equal to and substantially equal to a density of the fluid.

A2: A device according to any one of A-A1, wherein the housing comprises one of a spherical, cylindrical and rectangular shape.

A3: A device according to any one of A-A2, wherein the one of first physical, chemical and electrical signals comprise one of impedance, color, conductivity, optical absorbance, hydrogen ion concentration, temperature, pressure and velocity.

A4: A device according to any one of A-A3, wherein the location tracking device comprises an accelerometer.

A5: A device according to any one of A-A4, wherein the location tracking device further comprises one of a weld sensor, a gyroscope and an odometer.

A6: A device according to any one of A-A5, further comprising a second sensor partially within the housing that detects one of second physical, chemical and electrical signals of the fluid at the plurality of locations.

A7: A device according to A6, wherein the one of first physical, chemical and electrical signals is different from the one of second physical, chemical and electrical signals.

A8: A device according to any one of A-A7, further comprising a data acquisition unit within the housing and operatively connected to the first sensor, wherein the data acquisition unit converts the one of first physical, chemical and electrical signals into information about the tubular element.

A9: A device according to A8, wherein the information comprises at least one of a presence of water, solids and biofilm within the tubular element.

A10: A device according to any one of A8-A9, wherein the data acquisition unit operatively connects to the location tracking device.

B: A system for predicting corrosion in a tubular element that receives hydrocarbons may comprise a device constructed and arranged to predict corrosion in the tubular element, the device comprising: a first housing; a first sensor partially within the first housing and that detects one of first physical, chemical and electrical signals of a fluid within the tubular element at a plurality of locations within the tubular element; and a location tracking device within the first housing and operatively connected to the first sensor, wherein the location tracking device determines an axial and circumferential position of the first sensor at each of the plurality of locations.

B1: A system according to B, wherein the first housing comprises a material having a density one of equal to and substantially equal to a density of the fluid.

B2: A system according to any one of B-B1, wherein the first housing comprises one of a spherical, cylindrical and rectangular shape.

B3: A system according to any one of B-B2, wherein the one of first physical, chemical and electrical signals comprise one of impedance, color, conductivity, optical absorbance, hydrogen ion concentration, temperature, pressure and velocity.

B4: A system according to any one of B-B3, wherein the location tracking device comprises an accelerometer.

B5: A system according to any one of B-B4, wherein the location tracking device further comprises one of a weld sensor, a gyroscope and an odometer.

B6: A system according to any one B-B5, further comprising a moving mechanism constructed and arranged to move the first housing within the tubular element.

B7: A system according to B6, wherein the moving mechanism comprises the first housing, the first housing having a density one of equal to and substantially equal to a density of the fluid.

B8: A system according to any one of B6-B7, wherein the moving mechanism comprises a tubular element mechanism that moves within the tubular element and directly attaches to the first housing.

B9: A system according to B8, wherein the tubular element mechanism comprises one of a pig and a well logging tool.

B10: A system according to any one of B6-B7, wherein the moving mechanism comprises a tubular element body and a cable that attaches the tubular element body to the housing and extends from the tubular element body to the housing.

B11: A system according to B10, wherein the tubular element body comprises one of a pig and a well logging tool.

B12: A system according to any one of B-B11, further comprising a second sensor that measures one of second physical, chemical and electrical signals of the fluid at the plurality of locations.

B13: A system according to B12, wherein the second sensor is partially within the first housing.

B14: A system according to any one of B-B13, further comprising a second housing.

B15: A system according to any one of B12-B13, further comprising a second housing, wherein the second sensor is partially within the second housing.

B16: A system according to any one of B14-B15, wherein the second housing comprises a material having a density one of equal to and substantially equal to a density of the fluid.

B17: A system according to any one of B14-B16, wherein the second housing comprises one of a spherical, cylindrical and rectangular shape.

B18: A system according to any one of B12-B13 and B15-B17, wherein the one of the second physical, chemical and electrical signals comprise one of impedance, color, conductivity, optical absorbance, hydrogen ion concentration, temperature, pressure and velocity.

B19: A system according to any one of B12-B13 and B15-B18, wherein the one of first physical, chemical and electrical signals is different from the one of second physical, chemical and electrical signals.

C: A method of predicting corrosion in a tubular element that receives hydrocarbons may comprise measuring at least one of a first physical, chemical and electrical signal of a fluid within the tubular element at a first location within the tubular element using a sensor; determining a first axial and circumferential position of the sensor at the first location; moving the sensor to a second location within the tubular element that is different from the first location; and measuring at least one of a second physical, chemical and electrical signal of the sensor at the second location.

C1: A method according to C, wherein the one of first physical, chemical and electrical signals comprise one of impedance, color, conductivity, optical absorbance, hydrogen ion concentration, temperature, pressure and velocity.

C2: A method according to any one of C-C1, wherein the one of the second physical, chemical and electrical signals comprise one of impedance, color, conductivity, optical absorbance, hydrogen ion concentration, temperature, pressure and velocity.

C3: A method according to any one of C-C2, wherein the one of first physical, chemical and electrical signals is different from the one of second physical, chemical and electrical signals.

C4: A method according to any one C-C3, further comprising converting at least one of the first physical, chemical and electrical signals into first information about the tubular segment at the first location.

C5: A method according to any one of C-C4, further comprising determining a second axial and circumferential position of the sensor at the second location.

C6: A method according to any one of C-C5, further comprising converting at least one of the second physical, chemical and electrical signal into second information about the tubular element at the second location.

D: A method of producing hydrocarbons may comprise acquiring a hydrocarbon within a tubular element; and predicting corrosion in the tubular element, wherein the predicting includes: measuring at least one of a first physical, chemical and electrical signal of a sensor measuring at least one of a first physical, chemical and electrical signal of a fluid within the tubular element at a first location within the tubular element using a sensor; determining a first axial and circumferential position of the sensor at the first location; moving the sensor to a second location within the tubular element that is different from the first location; and measuring at least one of a second physical, chemical and electrical signal of the sensor at the second location.

D1: A method according to D, wherein the one of first physical, chemical and electrical signals comprise one of impedance, color, conductivity, optical absorbance, hydrogen ion concentration, temperature, pressure and velocity.

D2: A method according to any one of D-D1, wherein the one of the second physical, chemical and electrical signals comprise one of impedance, color, conductivity, optical absorbance, hydrogen ion concentration, temperature, pressure and velocity.

D3: A method according to any one of D-D2, wherein the one of first physical, chemical and electrical signals is different from the one of second physical, chemical and electrical signals.

D4: A method according to any one of D-D3, further comprising converting at least one of the first physical, chemical and electrical signal into first information about the tubular segment at the first location.

D5: A method according to any one of D-D4, further comprising determining a second axial and circumferential position of the sensor at the second location.

D6: A method according to any one of D-D5, further comprising converting at least one of the second physical, chemical and electrical signal into second information about the tubular element at the second location.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

It should be understood that the preceding is merely a detailed description of specific embodiments of this disclosure and that numerous changes, modifications, and alternatives to the disclosed embodiments can be made in accordance with the disclosure here without departing from the scope of the embodiments. The preceding description, therefore, is not meant to limit the scope of the embodiments. Rather, the scope of the embodiments is to be determined only by the appended claims and their equivalents. It is also contemplated that structures and features embodied in the present examples can be altered, rearranged, substituted, deleted, duplicated, combined, or added to each other.

The articles “the”, “a” and “an” are not necessarily limited to mean only one, but may rather be inclusive and open ended so as to include, optionally, multiple such elements.

What is claimed is:

1. A device for predicting corrosion in a tubular element that receives hydrocarbons, the device comprising:
a housing;
a first sensor partially within the housing and that detects one of first physical, chemical and electrical signals of a fluid within the tubular element at a plurality of locations within the tubular element; and
a location tracking device within the housing and operatively connected to the first sensor, wherein the location tracing device determines an axial and circumferential position of the first sensor at each of the plurality of locations.

2. The device of claim 1, wherein the housing comprises a material having a density one of equal to and substantially equal to a density of the fluid.

3. The device of claim 1, wherein the housing comprises one of a spherical, cylindrical and rectangular shape.

4. The device of claim 1, wherein the one of first physical, chemical and electrical signals comprise one of impedance, color, conductivity, optical absorbance, hydrogen ion concentration, temperature, pressure and velocity.

5. The device of claim 1, wherein the location tracking device comprises an accelerometer.

6. The device of claim 5, wherein the location tracking device further comprises one of a weld sensor, a gyroscope and an odometer.

7. The device of claim 1, further comprising a second sensor partially within the housing that detects one of second physical, chemical and electrical signals of the fluid at the plurality of locations.

8. The device of claim 7, wherein the one of first physical, chemical and electrical signals is different from the one of second physical, chemical and electrical signals.

9. The device of claim 1, further comprising a data acquisition unit within the housing and operatively connected to the first sensor, wherein the data acquisition unit converts the one of first physical, chemical and electrical signals into information about the tubular element.

10. The device of claim 9, wherein the information comprises at least one of a presence of water, solids and biofilm within the tubular element.

11. The device of claim 9, wherein the data acquisition unit operatively connects to the location tracking device.

12. A system for predicting corrosion in a tubular element that receives hydrocarbons, the system comprising:
a device constructed and arranged to predict corrosion in the tubular element, the device comprising:
a first housing;
a first sensor partially within the first housing and that detects one of first physical, chemical and electrical signals of a fluid within the tubular element at a plurality of locations within the tubular element; and
a location tracking device within the first housing and operatively connected to the first sensor, wherein the location tracking device determines an axial and circumferential position of the first sensor at each of the plurality of locations.

13. The system of claim 12, further comprising a moving mechanism constructed and arranged to move the first housing within the tubular element.

14. The system of claim 13, wherein the moving mechanism comprises the first housing, the first housing having a density one of equal to and substantially equal to a density of the fluid.

15. The system of claim 13, wherein the moving mechanism comprises a tubular element mechanism that moves within the tubular element and directly attaches to the first housing.

16. The system of claim 15, wherein the tubular element mechanism comprises one of a pig and a well logging tool.

17. The system of claim 13, wherein the moving mechanism comprises a tubular element body and a cable that attaches the tubular element body to the housing and extends from the tubular element body to the housing.

18. The system of claim 17, wherein the tubular element body comprises one of a pig and a well logging tool.

19. The system of claim 12, further comprising a second sensor that measures one of second physical, chemical and electrical signals of the fluid at the plurality of locations.

20. The system of claim 19, wherein the second sensor is partially within the first housing.

21. The system of claim 19, further comprising a second housing, wherein the second sensor is partially within the second housing.

22. A method of predicting corrosion in a tubular element that receives hydrocarbons, the method comprising:
measuring at least one of a first physical, chemical and electrical signal of a fluid within the tubular element at a first location within the tubular element using a sensor;
determining a first axial and circumferential position of the sensor at the first location;
moving the sensor to a second location within the tubular element that is different from the first location; and
measuring at least one of a second physical, chemical and electrical signal of the sensor at the second location.

23. The method of claim 22, further comprising converting at least one of the first physical, chemical and electrical signal into first information about the tubular segment at the first location.

24. The method of claim 22, further comprising determining a second axial and circumferential position of the sensor at the second location.

25. The method of claim 22, further comprising converting at least one of the second physical, chemical and electrical signal into second information about the tubular element at the second location.

26. A method of producing a hydrocarbon, the method comprising:
acquiring a hydrocarbon within a tubular element; and
predicting corrosion in the tubular element, wherein the predicting includes:
measuring at least one of a first physical, chemical and electrical signal of a sensor measuring at least one of a first physical, chemical and electrical signal of a fluid within the tubular element at a first location within the tubular element using a sensor;
determining a first axial and circumferential position of the sensor at the first location;
moving the sensor to a second location within the tubular element that is different from the first location; and
measuring at least one of a second physical, chemical and electrical signal of the sensor at the second location.
